(19) United States
(12) Patent Application Publication
(10) Pub. No.: US 2014/0232116 A1
(43) Pub. Date: Aug. 21, 2014

(54) HEAVE PLATES THAT PRODUCE LARGE RATES OF CHANGE IN TETHER TENSION WITHOUT GOING SLACK, AND ASSOCIATED SYSTEMS AND METHODS

(71) Applicant: University of Washington through its Center for Commercialization, Seattle, WA (US)

(72) Inventors: James M. Thomson, Seattle, WA (US); Joseph L. Talbert, Seattle, WA (US); Alex deKlerk, Seattle, WA (US); Curtis Rusch, Seattle, WA (US); Zachary Murphree, Seattle, WA (US)

(73) Assignee: University of Washington through its Center for Commercialization, Seattle, WA (US)

(21) Appl. No.: 14/186,577

(22) Filed: Feb. 21, 2014

Related U.S. Application Data
(60) Provisional application No. 61/767,689, filed on Feb. 21, 2013.

(51) Int. Cl. F03B 13/16; F03B 13/10

(52) U.S. Cl. CPC F03B 13/16; F03B 13/10
USPC 290/53

(57) ABSTRACT

Apparatuses and associated methods for converting wave energy into electrical energy are disclosed herein. In some embodiments, a surface-based buoy can be connected to a magnetostrictive element that changes its output voltage when subjected to the in tension. To keep the heave plate under tension, a tether with a heave plate can be attached to the magnetostrictive element. Since the magnetostrictive element can be sensitive to zero tension (e.g., a slack in the tether) followed by a sudden increase in the tension, in at least some embodiments it is preferred to keep the magnetostrictive element tensioned at all times. In some embodiments of the present technology, an inertia-dominated heave plate may be designed to sink faster than the buoy falls in the trough of the wave, therefore keeping the tether tensioned at all times. For example, the design (e.g., mass, diameter, height) of the heave plate can be such that the static force of gravity S exceeds a sum of the drag D and inertia I under expected wave conditions.

### CROSS-REFERENCE TO RELATED APPLICATIONS

This application claims the benefit of U.S. Provisional Application No. 61/767,689, filed Feb. 21, 2013.

### TECHNICAL FIELD

The present technology is generally related to systems that generate electrical energy from water waves. The systems typically include a buoy connected to a submerged electricity-generating device via a tether. In particular, several embodiments of the present technology are directed to heave plates that keep the tether under tension for a range of wave and/or tide events.

### BACKGROUND

Water wave energy is a known source of renewable energy. With some conventional technologies, a relatively light buoy is placed in a water body such that the buoy bobs up with a wave crest and down with a wave trough. This up and down motion of the buoy can be harnessed as renewable energy. For example, the buoy can be tethered to a device, e.g., a mechanical spring or a gas compressor, capable of storing the motion of the buoy as potential energy (e.g., spring force or gas pressure). Thus stored potential energy can be used to power, for example, an electrical generator, while the periodical motion of the buoy replenishes the stored potential energy. In some other devices, the tether can be connected to a magnetostrictive element that generates electrical power when the tension changes in the magnetostrictive element. Some magnetostrictive elements output a base voltage when not in tension. As the tension force in the element increases, the output voltage of the element also increases above the base voltage in some proportion to the tension force. Therefore, when the motion of the buoy tensions a tether connected to the magnetostrictive element, the changing tension in the element results in a corresponding change in voltage at the element. These voltage changes can be harnessed to usable electrical energy using appropriate power conditioning electronics.

A magnetostrictive element that is packaged, equipped with the electrical conductors, and configured to attach to a tether is known as a power take-off (PTO) unit. When attached to the tether, the PTO can handle large tension forces and convert them into the corresponding voltage changes. However, the PTOs can be sensitive to slack in the tether. For example, the PTO can be damaged by a loss of the tension force (corresponding to the slack of the tether), followed by a sudden increase in the tension force (corresponding to the buoy-induced tension in the tether). With some conventional technologies, the tether is attached to a heave plate that can smooth-out and average the tension events in the tether, with a goal of eliminating slack in the tether and the PTO. Some examples of the heave plates in accordance with the conventional technology are described below in relation to FIGS. 1 and 2.

FIG. 1, for example, is a partially schematic side view of a heave plate configured in accordance with the conventional technology. In the illustrated system 100, a buoy 15 is connected to a heave plate 11 by tethers 13. Several PTOs 10 are connected to their corresponding tethers 13. The system 100 can be moored by a mooring line 16 connected to an anchor 14 to keep the system from drifting away. In operation, when a crest of a water wave 17 lifts the buoy 15, the upward motion of the buoy is resisted by a drag force of the heave plate 11. As a result, the tethers 13 and PTOs 10 are tensioned, causing the corresponding change of the PTO voltage that can be harnessed out of the system through appropriate power conditioning electronics (not shown). Generally, to increase the tension in the tethers 13 and PTOs 10, it is preferred to minimize a vertical motion of the buoy (as the buoy experiences the crest of the wave 17). This upward motion of the buoy can be decreased by increasing a drag force of the heave plate 11, which, in turn, increases with the diameter of the heave plate 11. However, when a wave trough reaches the buoy 15, a relatively large drag of the heave plate 11 slows the downward sinking of the heave plate 11, resulting in a reduced tension in the tethers 13 and PTOs 10. Under some conditions, the PTOs 10 may completely lose tension (i.e., become slack) due to the relatively high drag force that slows the sinking of the heave plate 11. As explained above, loss of tension in the PTO followed by sudden tensioning may damage the PTOs. To minimize this problem, the heave plate 11 can include perforations 12 that reduce the drag force when the heave plate 11 moves down. However, the perforations 12 also reduce drag force when the heave plate 11 moves up (e.g., when the next wave crest lifts the buoy 15), thus reducing the maximum tension in the tethers 13 and PTOs 10. A reduction in the tension of the PTOs is undesirable because, in general, the PTOs produce more energy when the tension force is higher.

FIG. 2 is a partially schematic side view of a heave plate configured in accordance with another embodiment of the conventional technology. A system 200 includes the buoy 15, tethers 13, PTOs 10, mooring lines 16, and the anchor 14 like those described above in relation to system 100 of FIG. 1. The illustrated system 200 also includes a heave plate 22 having a generally conical shape. As a result, the drag force is higher when the heave plate 22 moves up (e.g., when the buoy 15 experiences a wave crest) than when it moves down (e.g., when the buoy 15 experiences a wave trough). A higher drag force increases tension in the tethers 13 and the PTOs 10, while a smaller drag force may reduce and/or eliminate slack in the tethers 13 and PTOs 10. However, the heave plate 22 also suffers from various shortcomings. For example, the relatively complex shape of the heave plate 22 increases the cost of the system 200. Furthermore, it is generally difficult to design a conical heave plate that will have desired drag under different wave and/or tidal conditions experienced by the buoy 15.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic side view of a heave plate configured in accordance with conventional technology.

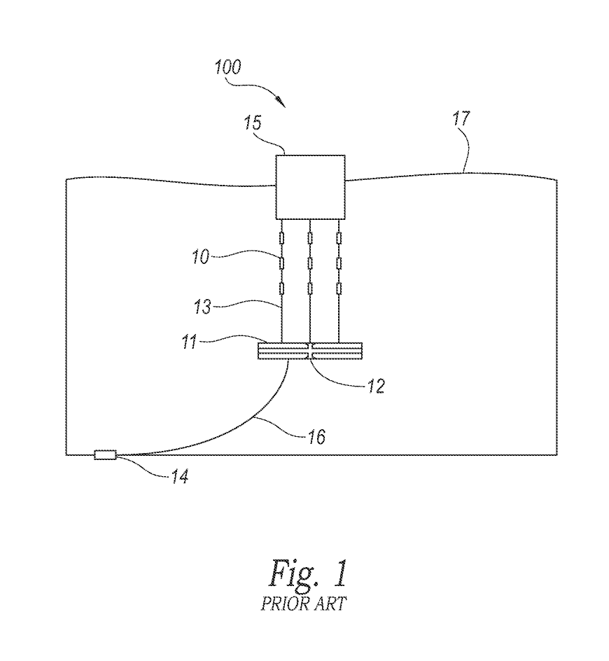

FIG. 2 is a partially schematic side view of a heave plate configured in accordance with another embodiment of conventional technology.

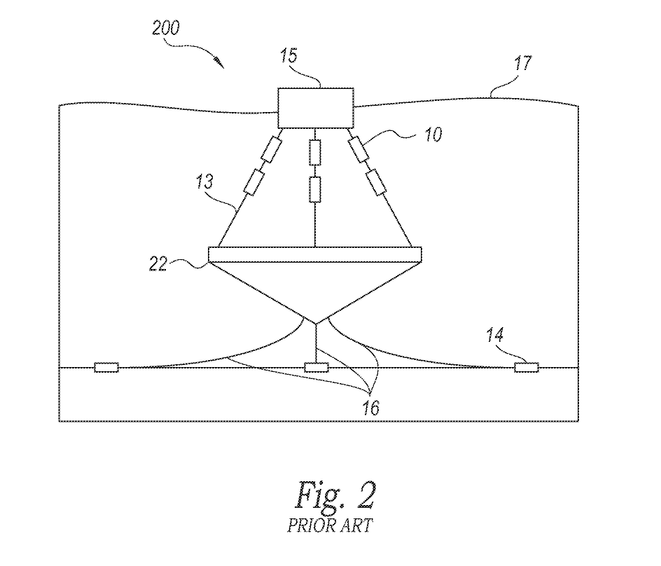

FIG. 3 is a partially schematic side view of a system for generating energy from water waves configured in accordance with the present technology.

FIGS. 4A-4D are graphs of the surface wave parameters and tether tension for a system configured in accordance with embodiments of the present technology.

FIG. 5 is a schematic illustration of a location of heave plate in accordance with the present technology.

FIGS. 6A-6B are graphs illustrating system performance for a system configured in accordance with embodiments of the present technology.

FIG. 7 is a partially schematic side view of a system for generating energy from water waves being installed in accordance with an embodiment of the present technology.

### DETAILED DESCRIPTION

The present technology relates to systems and methods for generating electrical energy from water waves. In some embodiments, a surface-based buoy can be connected to the magnetostrictive elements (e.g., power take-off units or PTOs) that produce different output voltage as tension changes in the PTOs. Since the PTOs can be sensitive to zero tension followed by a sudden increase in tension, it is preferred to keep the PTOs tensioned at all times. Therefore, in some embodiments of the present technology, a heave plate can be attached to a tether that is connected to the PTOs. The heave plate can be inertia dominated to provide tension in the tether and the PTOs for a range of expected wave and/or tide events. According to embodiments of the present technology, the inertia dominated heave plate is designed to sink faster than the buoy falls into the trough of the wave, therefore keeping the tether tensioned at all times. For example, design parameters of the heave plate (e.g., mass, diameter, height) can be selected such that the static force of gravity (S) exceeds a sum of the drag (D) and inertia (I) under expected wave conditions. Therefore, even under challenging conditions (e.g., drag (D) and inertia (I) pointing upwards as the buoy goes through the wave trough), a relative dominance of the static force of gravity (S) (pointing downward) over the sum of the drag (D) and inertia (I) (pointing upward) assures tension in the tether and the PTOs. In some embodiments, the heave plate is located at a depth where the wave orbital motion is reduced.

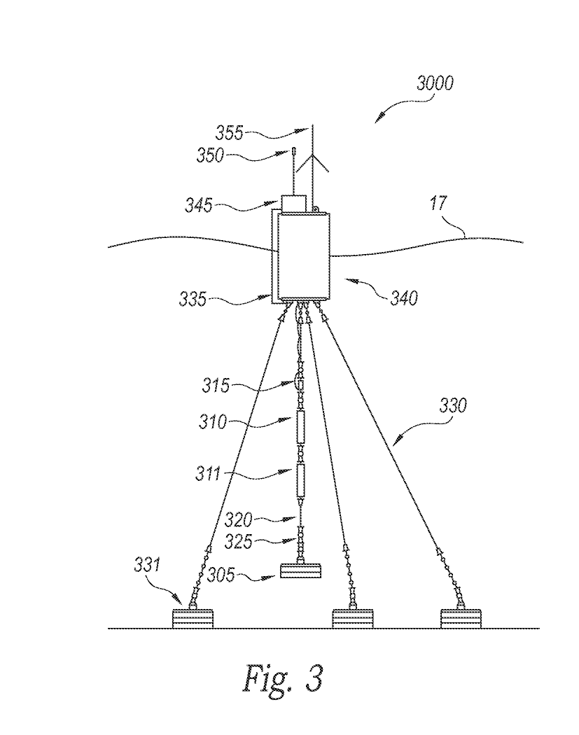

FIG. 3 is a partially schematic side view of a system 3000 for generating energy from water waves configured in accordance with the present technology. The system 3000 includes a buoy 340 that can be moored by connecting mooring lines 330 to corresponding anchors 331 at the bottom of the body of water. The mooring lines 330 keep the buoy 340 in a generally fixed location and help prevent the buoy 340 from drifting away. With the illustrated system 3000, two PTOs 310, 311 are connected to the buoy 340. It will be appreciated, however, that different numbers of PTOs can also be used with the system 3000. A heave plate 305 can be connected to the PTOs 310, 311 using a tether 320. As explained in more detail below, the inertia dominated heave plate 305 can be designed such that the tether 320 remains in tension for all expected wave and/or tide conditions. In some embodiments, the tension in the tether 320 can be monitored by a load cell 315 and the data can be fed to a data logger 345 through a cable 335. A swivel 325 can be used to reduce and/or eliminate torsion in the tether 320 and the PTOs 310, 311. Energy extracted from the PTOs 310, 311 can be stored onboard (e.g., in a battery system, not shown) or transferred onshore (e.g., using electrical cables, not shown). In some embodiments, the system 3000 can be equipped with a wind generator 355 to provide, for example, at least a portion of the energy required for the onboard measurement instruments and power electronics. The system 3000 can also include a safety flashing light 350.

Generally, the forces acting on the heave plate 305 can be summarized as follows: (1) static force of gravity S, adjusted for displacement of water by the volume of the heave; (2) drag force D experienced by the heave as it moves through the water, and (3) inertial force I required to accelerate the heave plate through the water. For a heave plate having a volume V, the static force of gravity S can be calculated as:

S=mg−ρVg

where m is a mass of the heave plate, g is a gravitational acceleration, ρ is density of water, and V is the volume of the heave (i.e., the displacement volume). The drag force (D) can be approximated as:

D=½ρC_{d}w|w|A

where C_{d} is a drag coefficient (e.g., about 1.1 for a cylindrical plate), w is a vertical velocity of a wave motion, and A is a cross-sectional area of the heave plate in a plane parallel to the free surface of the body of water (e.g., R²Π for a cylinder moving in the direction of its longitudinal axis). Based on the linear theory for waves in deep water, the vertical velocity of a wave motion can be expressed as:

$$w = ( \frac{H}{2} ) ωcos ( ω t )$$

where H is a wave height, and ω is wave frequency in radians.

The inertial force (I) can be approximated as:

I=Cₘma

where Cₘ is a coefficient of added mass (typically around 1.2 for generally cylindrical plates), and a is the acceleration of the heave plate. Using the linear theory for the waves, the acceleration a can be calculated as:

$$a = ( \frac{H}{2} ) {ω}^{2} sin ( ω t )$$

Since S always points downward (in the direction of the gravitational acceleration, i.e., toward a bottom of the body of water), and D and I can point either downward or upward depending on the direction of the heave plate motion at a given time, the worst design case for the occurrence of the slack in the tether is when both D and I point upward. Therefore, the following inequality expresses a condition that produces no slack in the tether:

S>D+I

When the S, D, and I are replaced with their respective expressions, the following inequality is obtained:

$$m g - ρ V g > \frac{1}{2} ρ {{C}_{d} ( \frac{H}{2} ) [ ω cos ( ω t ) ]}^{2} A + {C}_{m} m ( \frac{H}{2} ) {ω}^{2} sin ( ω t ) \qquad ( 1 )$$

Since the electrical output of the PTOs depends on their tension, in some embodiments of the present technology a desired tether tension change T can be set at, for example, twice the inertial force I of the heave plate (i.e., ΔT=2I). This will assure that the tension in the PTOs changes from maximum to minimum (corresponding to wave crest and wave trough, respectively) for about ±I. Having selected the inertial force (i.e., I=½ΔT), a maximum cross-sectional area A of the heave plate to avoid tether slack can be determined using Eq. (1). Rearranging the terms of Eq. (1), the maximum cross-sectional area of the heave plate can be determined as:

$$A < ( \frac{m g - ρ V g - {C}_{m} m ( \frac{H}{2} ) {ω}^{2}}{\frac{1}{2} ρ {C}_{d} {m ( \frac{H}{2} )}^{2} {ω}^{2}} ) \qquad ( 2 )$$

Since Eq. (2) includes parameters of the surface wave (e.g., H,ω), in at least some embodiments of the present technology the choice of the cross-sectional area A of the heave plate and the corresponding tether tension T will depend on the local surface wave conditions.

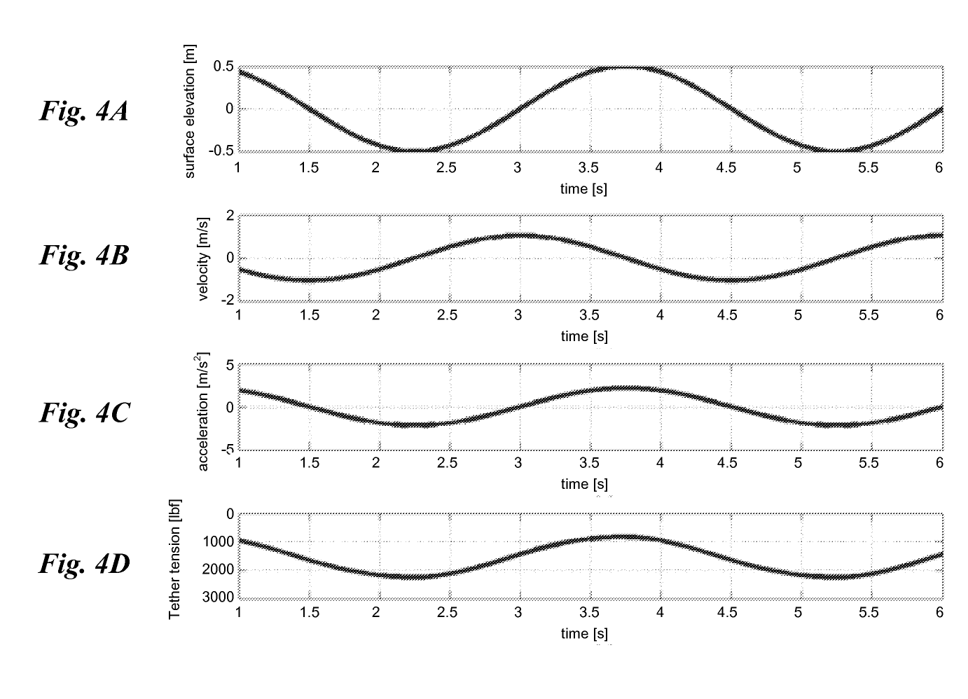

FIGS. 4A-4D are graphs of the surface wave parameters and tether tension for a system configured in accordance with embodiments of the present technology. The horizontal axes in the graphs in FIGS. 4A-4D represent time in seconds. The illustrated water waves have a period of about 3 seconds. The vertical axes in the graphs represent surface elevation (FIG. 4A), surface velocity (FIG. 4B), surface acceleration (FIG. 4C), and the corresponding tether tension (FIG. 4D). The graphs show that for a wave elevation of about +/−0.5 m (i.e., the wave crest and trough at about +/−0.5 m in FIG. 4A), the wave velocity is within a range of +/−1.02 m/s (FIG. 4B), and the corresponding wave acceleration is within a range of +/−2.2 m/s² (FIG. 4C). The illustrated wave parameters may be representative for relatively large lakes, but the wave elevation may be larger in, for example, the ocean. For the wave parameters illustrated in FIGS. 4A-4C, and selecting a heave plate of about 1800 lb, Eq. (2) yields value of A<2 m² to avoid slack conditions in the tether and the PTOs. For additional safety (e.g., to keep the tether tension safely above 0 lbf), the mass of the heave plate can be increased. For example, FIG. 4D shows a tether force ranging from about 800 lbf to about 2200 lbf when the heave plate has a mass of about 2640 lb for a cylindrical heave plate having a radius of 0.5 m. Therefore, with this choice of the heave plate parameters (and under given wave conditions), the tether and the PTOs should always be under at least 800 lbf of tension. In general, with the embodiments of the present technology, the heave plate design can be optimized for particular wave conditions at a given location.

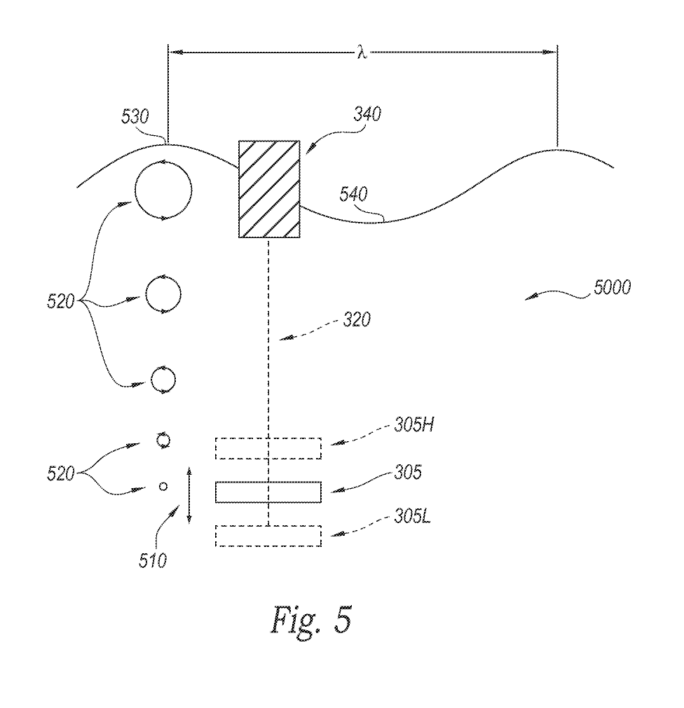

In some embodiments, a heave plate can be placed at a sufficient depth such that orbital motions of the wave are reduced around the heave plate. FIG. 5, for example, is a schematic illustration of a location of heave plate in accordance with the present technology. Illustrated system 5000 is simplified for purposes of illustration and does not show some elements typically present in systems that extract energy from the water waves. For example, the system 5000 does not show the PTOs. The system 5000 includes the buoy 340 connected with the tether 320 to the heave plate 305. As the buoy 340 moves up with a wave crest 530 and down with a wave trough 540, the heave plate 305 also moves up and down from its upper limit position 305H to its lower limit position 305L, as illustrated with arrows 510. A series of orbital waves 520 develops due to the water wave crest/through 530/540 at the surface of the water. Size of the orbital waves 520 diminishes in the direction away from the free surface of the water. Generally, when the orbital waves 520 are smaller, the additional drag forces on the heave plate 305 are also smaller. Therefore, in some embodiments of the present technology, the heave plate 305 can be placed at a depth of about one half of a wavelength λ or deeper to control the drag forces on the heave plate 305.

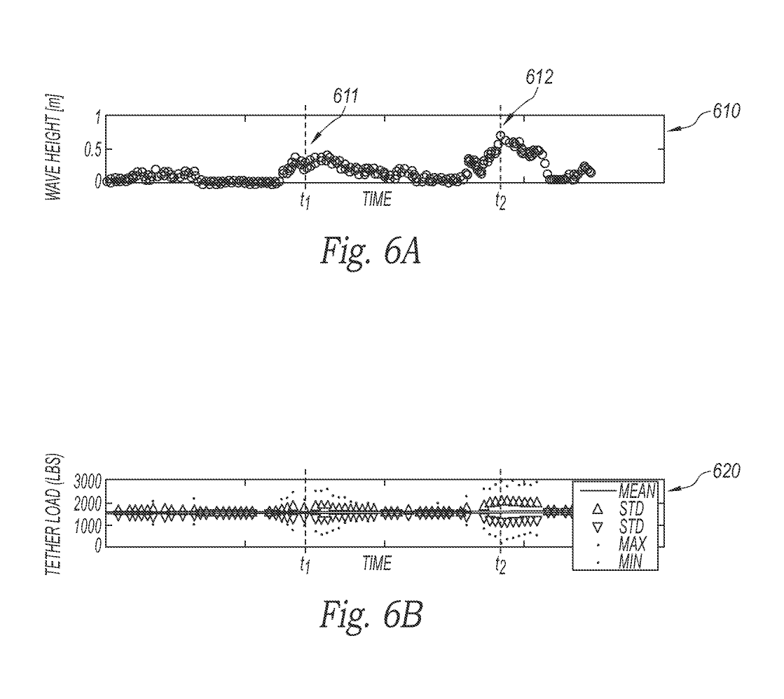

FIGS. 6A and 6B are graphs illustrating system performance for a system configured in accordance with embodiments of the present technology. The horizontal axes in graphs 610, 620 represent time. The vertical axes in the graphs 610 and 620 represent wave height and tether load, respectively. The graph 610 shows a range of wave heights, from 0 m to about 0.7 m, occurring over the relevant timespan. Two relatively large wave events 611, 612 occurred at the times t₁ and t₂, respectively. The wave events 611, 612 included the waves about 0.4 and 0.7 m high, respectively. As explained above with reference to FIG. 3, systems that include heave plates and tethers are susceptible to undesired slack in the tethers at maximum wave events, such as the wave events 611, 612. However, graph 620 shows that the tether load remained positive (i.e., the tether is in tension) at all times using a system configured according to embodiments of the present technology. For example, the minimum tether force corresponding to the large wave event 612 is still positive. Furthermore, all the statistical means are positive at all measured times, even when reduced by several multiples of the standard deviation. Such data demonstrate a robustness of the system in maintaining the tension force in the tether.

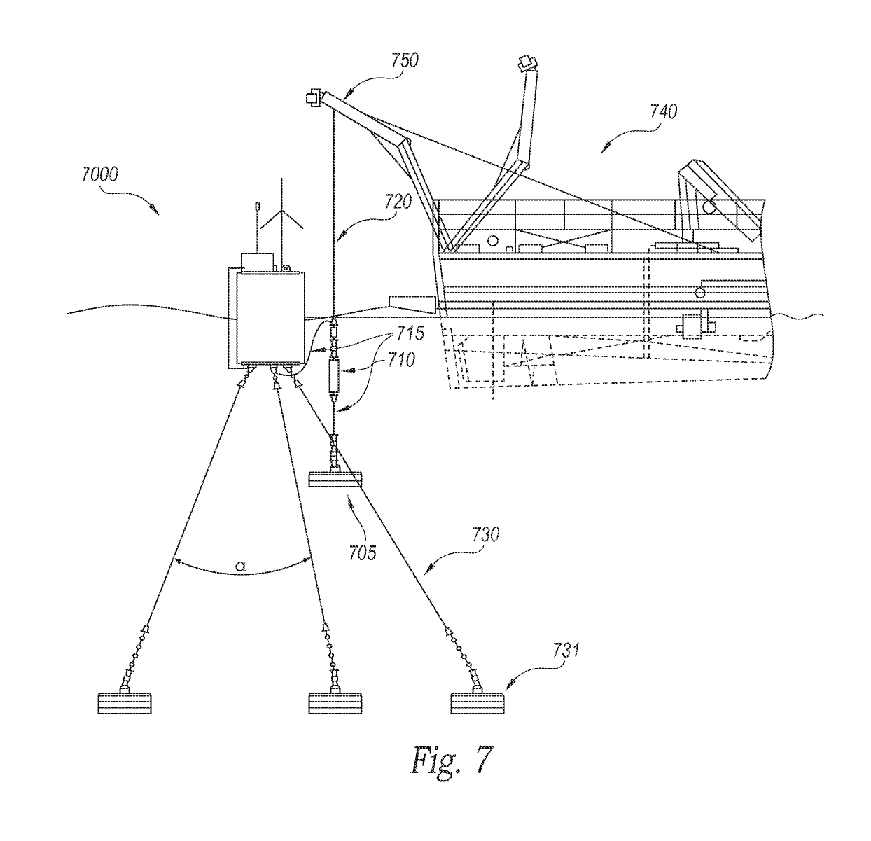

FIG. 7 is a partially schematic side view of a system 7000 for generating energy from water waves being installed in accordance with an embodiment of the present technology. The system 7000 may be generally similar to the system 3000 described with reference to FIG. 3. The system 7000 can include three mooring lines 730 connected to respective anchors 731. The illustrated mooring lines 730 spaced apart from each other by an angle α (e.g., 120°). In some embodiments of the present technology, a relatively large angle α between the mooring lines 730 enables easier installation and recovery of a heave plate 705. For example, a vessel 740 having an A-frame 750 and a cable 720 can lower the heave plate 705, PTO 710, and tether 715 below the water surface in the space between the mooring lines 730, thus simplifying the installation process. Furthermore, when uninstalling the system 7000, the heave plate 705 (and the elements attached to it) can be lifted out of the water and loaded on the vessel 740 using again the space between two mooring lines 730. This can be followed by lifting other elements of the system 7000 out of the water, and loading them on the vessel 740.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology. For example, although many of the embodiments are described with respect to the power take-off (PTO) unit, other devices capable of converting tether tension into useful energy are also possible. In some embodiments multiple tethers with heave plates can be attached to a buoy. Furthermore, in some embodiments, a heave plate may have shapes different from the cylindrical shape. For example, the heave plate may be generally spherical, generally cubical, or may have other shapes or combination of shapes. Further, while steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. An apparatus for generating energy from water waves, the apparatus comprising:
a converter connected to a buoy deployed in a body of water, wherein the converter is configured to convert changes in tensile force to electrical energy; and an inertia-dominated heave plate connected to the converter with a tether,
wherein the heave plate is sized and shaped to keep the tether under tension as the heave plate moves up and down relative to a surface below the body of water.

2. The apparatus of claim 1 wherein the buoy is anchored at three points with mooring lines, and wherein the three points are located generally equi-distantly along a circle passing through the three points.

3. The apparatus of claim 2 wherein the tether is separate from the mooring lines.

4. The apparatus of claim 1 wherein the heave plate is generally free of apertures in a direction of the tether.

5. The apparatus of claim 1 wherein the heave plate has a diameter of about 1 meter and dry weight of about 2600 lb.

6. The apparatus of claim 1 wherein the tension in the tether changes from about 800 lbf to about 2200 lbf when the buoy operates.

7. The apparatus of claim 1 wherein the heave plate is located at a depth that is larger than about one-half of a dominant wave length.

8. The apparatus of claim 1 wherein the tension in the tether changes as:
T=S+D+I
where S is a static force of gravity, D is a drag force, and I is an inertial force; and wherein S is always larger than a sum of S and I when the buoy operates.

9. The apparatus of claim 1 wherein the heave plate has a cross-sectional area (A) in a plane of a free surface of the body of water, and wherein A satisfies:
$$A < ( \frac{m g - ρ V g - {C}_{m} m ( \frac{H}{2} ) {ω}^{2}}{\frac{1}{2} ρ {C}_{d} {m ( \frac{H}{2} )}^{2} {ω}^{2}} )$$
where m is a mass of the heave plate, g is a gravitational acceleration, ρ is a density of water, V is a volume of the heave plate, Cₘ is a coefficient of added mass, H is a wave height, ω is a wave frequency in radians, and C_{d} is a drag coefficient of the heave plate.

10. A method for generating energy from water waves, the method comprising:
tensioning a tether with an inertia-dominated heave plate, wherein the tether is connected to a converter, and wherein the converter is coupled to a buoy deployed in a body of water; and
converting a tension to electrical energy via the converter,
wherein the tether is always under the tension when in operation.

11. The method of claim 10, further comprising transmitting the electrical energy onshore.

12. The method of claim 10, further comprising connecting the tether to the converter.

13. The method of claim 10, further comprising connecting the buoy to the converter.

14. The method of claim 13, further comprising anchoring the buoy at three points with mooring lines, wherein the three points are located generally equi-distantly along a circle passing through the three points.

15. The method of claim 14 wherein the tether is separate from the mooring lines.

16. The method of claim 14, further comprising removing the mooring lines and tether, wherein the tether is removed before the mooring lines are removed.

17. The method of claim 10 wherein tensioning the tether generates a tension force:
T=S+D+I
where S is a static force of gravity, D is a drag force, and I is an inertial force; and wherein S is always larger than a sum of D and I when the buoy operates.

18. The method of claim 10 wherein the heave plate has a cross-sectional area A in a plane of a free surface of the body of water, and wherein A satisfies:
$$A < ( \frac{m g - ρ V g - {C}_{m} m ( \frac{H}{2} ) {ω}^{2}}{\frac{1}{2} ρ {C}_{d} {m ( \frac{H}{2} )}^{2} {ω}^{2}} )$$
where m is a mass of the heave plate, g is a gravitational acceleration, ρ is a density of water, V is a volume of the heave plate, Cₘ is a coefficient of added mass, H is a wave height, ω is a wave frequency in radians, and C_{d} is a drag coefficient of the heave plate.
